(19) United States
(12) Patent Application Publication
(10) Pub. No.: US 2017/0038958 A1
(43) Pub. Date: Feb. 9, 2017

(54) SYSTEMS AND METHODS FOR GESTURE-BASED MODIFICATION OF TEXT TO BE INPUTTED

(71) Applicant: Facebook, Inc., Menlo Park, CA (US)

(72) Inventors: Robert Benson Walton, San Francisco, CA (US); Eugenio Padilla Garza, San Francisco, CA (US)

(21) Appl. No.: 14/820,060

(22) Filed: Aug. 6, 2015

(51) Int. Cl. G06F 3/0488; G06F 17/21; G06F 3/0484

(52) U.S. Cl. CPC G06F 3/04883; G06F 3/04847; G06F 17/214

(57) ABSTRACT

Systems, methods, and non-transitory computer-readable media can present a graphical element indicating that text is capable of being provided as input. A gesture performed with respect to the graphical element can be detected. At least one property associated with text to be provided as input can be modified based on the gesture performed with respect to the graphical element.

### FIELD OF THE INVENTION

The present technology relates to the field of providing content. More particularly, the present technology relates to techniques for gesture-based modification of text to be inputted.

### BACKGROUND

Today, people often utilize computing devices (or systems) for a wide variety of purposes. Users can use their computing devices, for example, to interact with one another, access content, share content, and create content. In some cases, users can utilize their computing devices to write, dictate, or otherwise provide content. Users can, for instance, utilize computing devices to type or input various characters or keys, such as to create text. In one example, a user can utilize a computing device to draft, write, or compose an electronic mail (email), a text message, a chat message, and/or another communication. In another example, a user of a social networking system (or service) can utilize his or her computing device to write, type, or otherwise input text to be used for posts, such as status updates, which can then be published via the social networking system.

Under conventional approaches to inputting text, computing devices such as smartphones and tablets can enable users to input text via digital keyboards presented on touch displays. Often times, the display space of such touch displays can be limited, resulting in smaller digital keyboards with smaller digital keys. Accordingly, it can be inconvenient or challenging for users to provide input via the smaller digital keyboards with the smaller digital keys, in accordance with conventional approaches. Moreover, such conventional approaches can also cause inconvenience or difficulty for users to format or style inputted text. As such, conventional approaches can create challenges for or reduce the overall user experience associated with inputting text.

### SUMMARY

Various embodiments of the present disclosure can include systems, methods, and non-transitory computer readable media configured to present a graphical element indicating that text is capable of being provided as input. A gesture performed with respect to the graphical element can be detected. At least one property associated with text to be provided as input can be modified based on the gesture performed with respect to the graphical element.

In an embodiment, detecting the gesture can include detecting that at least one of a tap or a click is performed with respect to the graphical element. Modifying the at least one property associated with the text to be provided as input can include activating or deactivating a bold style for the text to be provided as input.

In an embodiment, detecting the gesture can include detecting that a first swiping gesture within an allowable deviation of being along a first axis is performed with respect to the graphical element. Modifying the at least one property associated with the text to be provided as input can include activating or deactivating an italic style for the text to be provided as input.

In an embodiment, the first axis can correspond to a horizontal axis. The italic style can be activated when the first swiping gesture is performed in a rightward direction. The italic style can be deactivated when the first swiping gesture is performed in a leftward direction.

In an embodiment, detecting the gesture can include detecting that a second swiping gesture within an allowable deviation of being along a second axis is performed with respect to the graphical element. Modifying the at least one property associated with the text to be provided as input can include increasing or decreasing at least one of a font size or a header style significance for the text to be provided as input.

In an embodiment, the second axis can correspond to a vertical axis. The at least one of the font size or the header style significance can be increased when the second swiping gesture is performed in an upward direction. The at least one of the font size or the header style significance can be decreased when the second swiping gesture is performed in a downward direction.

In an embodiment, detecting the gesture can include detecting that a pressing gesture is performed with respect to the graphical element for at least a specified threshold amount of time. Modifying the at least one property associated with the text to be provided as input can include switching through a set of header styles for the text to be provided as input.

In an embodiment, detecting the gesture can include detecting that a pressing gesture is performed with respect to the graphical element for at least a specified threshold amount of time. Modifying the at least one property associated with the text to be provided as input can include activating or deactivating an underline style for the text to be provided as input.

In an embodiment, an appearance of the graphical element can be modified, based on the gesture, via a transitional animation.

In an embodiment, the appearance of the graphical element can be associated with one or more characters presented within an icon. Modifying the appearance of the graphical element can include at least one of switching between a bold style and a non-bold style for the one or more characters, switching between an italic style and a non-italic style for the one or more characters, switching between an underline style and a non-underline style for the one or more characters, switching through font sizes for the one or more characters, or switching through header styles for the one or more characters.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example gesture-based text modification module configured to facilitate gesture-based modification of text to be inputted, according to an embodiment of the present disclosure.

FIG. 2A illustrates an example gesture module configured to facilitate gesture-based modification of text to be inputted, according to an embodiment of the present disclosure.

FIG. 2B illustrates an example text property module configured to facilitate gesture-based modification of text to be inputted, according to an embodiment of the present disclosure.

FIG. 3A illustrates an example scenario associated with gesture-based modification of text to be inputted, according to an embodiment of the present disclosure.

FIG. 3B illustrates an example scenario associated with gesture-based modification of text to be inputted, according to an embodiment of the present disclosure.

FIG. 4A illustrates an example scenario associated with gesture-based modification of text to be inputted, according to an embodiment of the present disclosure.

FIG. 4B illustrates an example scenario associated with gesture-based modification of text to be inputted, according to an embodiment of the present disclosure.

FIG. 5 illustrates an example method associated with gesture-based modification of text to be inputted, according to an embodiment of the present disclosure.

FIG. 6 illustrates an example method associated with gesture-based modification of text to be inputted, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Gesture-Based Modification of Text to be Inputted

People use computing devices (or systems) for various purposes. Computing devices can provide different kinds of functionality. Users can utilize their computing devices to create or produce content, such as by writing text, taking pictures, or recording videos. Users can also use their computing devices to consume content, such as by reading status updates, browsing through articles, viewing media, or accessing web resources (e.g., web sites, online services, etc.). In some cases, computing devices can provide digital keyboards via touch screens that enable users to type, write, or otherwise input text. The inputted text can, for instance, be utilized for various purposes, such as to form an email, a text message, a chat message, a post, or another communication.

Under conventional approaches to inputting text, computing devices such as tablets and smartphones generally include touch screens capable of providing digital keyboards with digital keys, which can enable users to type or input characters. However, the touch screens can have limited display space. Providing larger digital keyboards can be disadvantageous or inefficient because the larger digital keyboards can take up valuable limited display space, which can prevent other content or substance from being presented via the touch screens. As such, the limited display space of such touch screens can cause digital keyboards and digital keys to be smaller. As a result, such conventional approaches can cause inconvenience or difficulty for users to type text.

Furthermore, conventional approaches can create challenges for or reduce the overall user experience associated with formatting, styling, or otherwise modifying text to be inputted. Under conventional approaches, users typically have to perform a significant amount of operations in order to format or style text to be inputted. For example, in the limited display space, a user may have to select text that he or she desires to format or style, browse through many options to identify the desired formatting/style option, and then select the desire option. Therefore, such conventional approaches can be cumbersome and can require significant effort and time.

Due to these or other concerns, conventional approaches can be inconvenient, inefficient, or undesirable. Therefore, an improved approach can be beneficial for addressing or alleviating various drawbacks associated with conventional approaches. The disclosed technology can provide gesture-based modification of text to be inputted. Various embodiments of the present disclosure can present a graphical element indicating that text is capable of being provided as input. A gesture performed with respect to the graphical element can be detected. At least one property associated with text to be provided as input can be modified based on the gesture performed with respect to the graphical element. It is contemplated that there can be many variations and/or other possibilities.

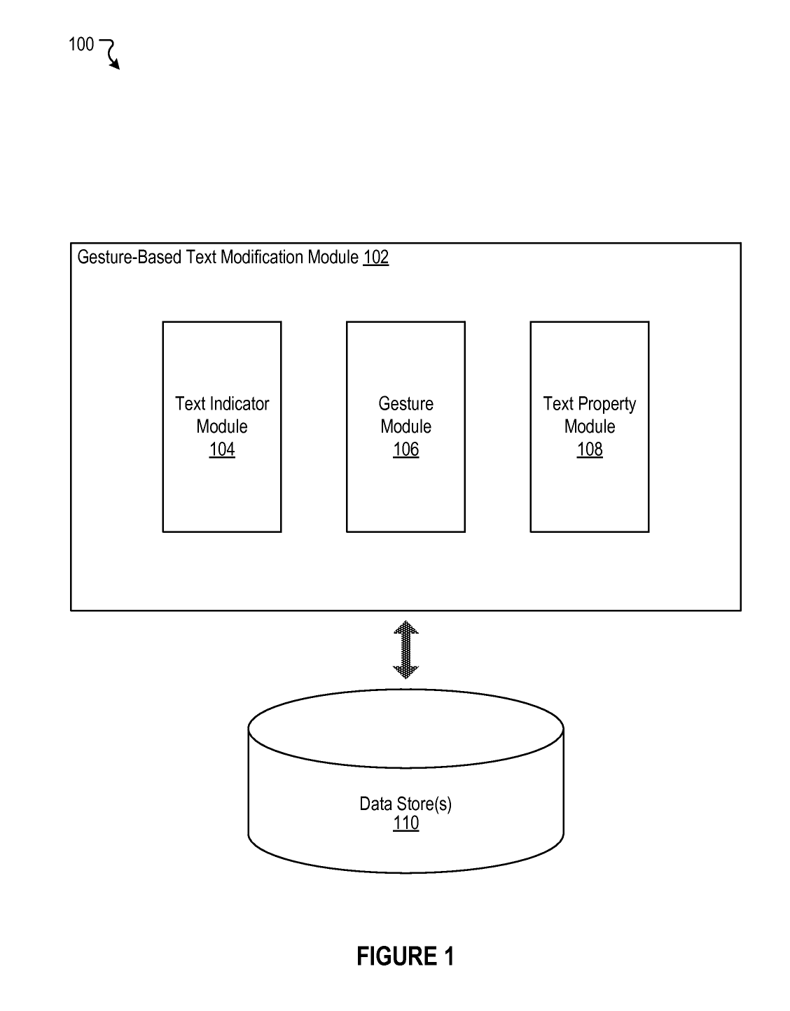

FIG. 1 illustrates an example system 100 including an example gesture-based text modification module 102 configured to facilitate gesture-based modification of text to be inputted, according to an embodiment of the present disclosure. As shown in the example of FIG. 1, the gesture-based text modification module 102 can include a text indicator module 104, a gesture module 106, and a text property module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

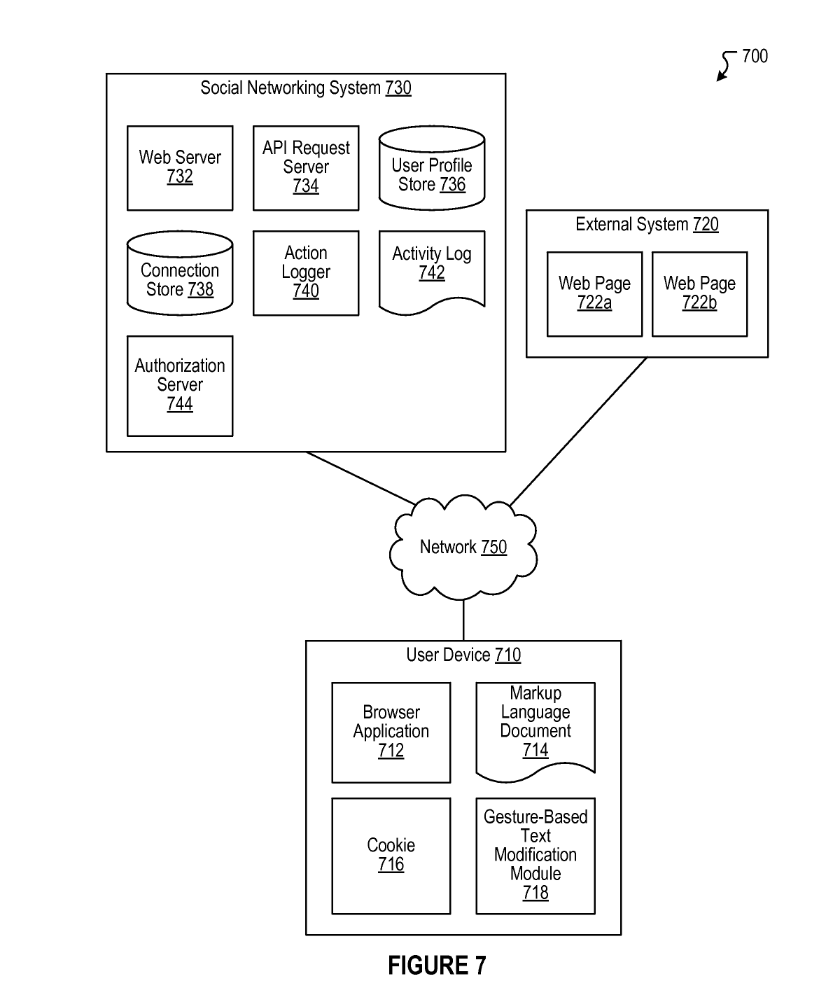

In some embodiments, the gesture-based text modification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the gesture-based text modification module 102 can be implemented, in part or in whole, as software running on one or more computing devices or systems, such as on a user or client computing device. For example, the gesture-based text modification module 102 or at least a portion thereof can be implemented as or within an application (e.g., app), a program, an applet, or an operating system, etc., running on a user computing device or a client computing system, such as the user device 710 of FIG. 7. In another example, the gesture-based text modification module 102 or at least a portion thereof can be implemented using one or more computing devices or systems that include one or more servers, such as network servers or cloud servers. In some instances, the gesture-based text modification module 102 can, in part or in whole, be implemented within or configured to operate in conjunction with a social networking system (or service), such as the social networking system 730 of FIG. 7. It should be understood that there can be many variations or other possibilities.

The text indicator module 104 can be configured to facilitate presenting a graphical element indicating that text is capable of being provided as input. The text indicator module 104 can present the graphical element in attempt to specify or denote, to a user of a computing device (or system) who is providing input, that the input to be received by the computer device is set as being text. In some cases, the text indicator module 104 can present the graphical element to distinguish the type of input set to be received, which is text, from other types of input options, such as a camera option, a photo or video option, an emoticon or emoji option, an animated image (e.g., GIF) option, a voice recording option, a transaction option, a location option, and/or a like option, etc. The other types of input options can be associated with respective other graphical elements as well.

In some embodiments, the text indicator module 104 can cause the graphical element to appear as one or more characters. In one example, the text indicator module 104 can cause the graphical element to appear as an icon with the characters “A”, “Aa”, “Abc”, or “ABC”, etc. In another example, the text indicator module 104 can cause the graphical element to appear as an icon that spells “Text”, “Text Input”, or “Type Text”, etc. In a further example, the text indicator module 104 can cause the graphical element to appear as a name of a font type. It should be understood that all examples herein are provided for illustrative purposes and that many variations are possible.

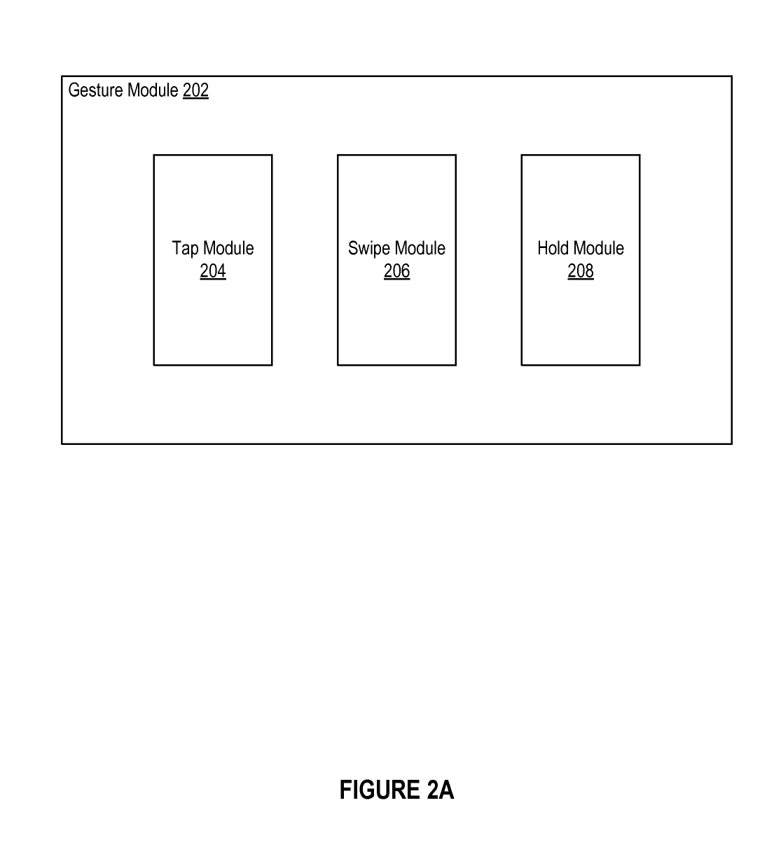

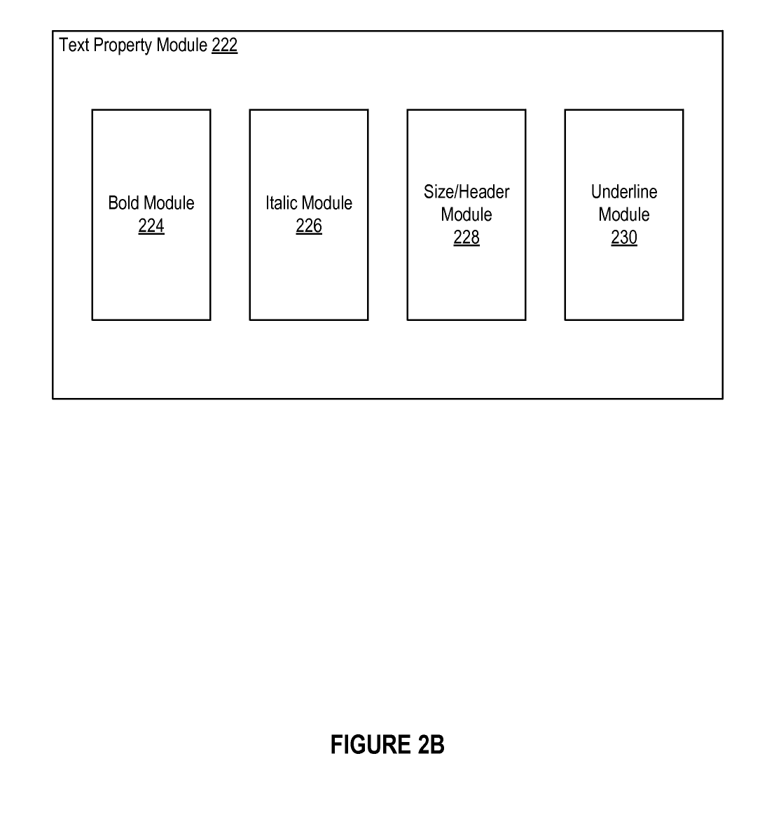

The gesture module 106 can be configured to facilitate detecting a gesture performed with respect to the graphical element. For instance, the graphical element can be presented at a certain region of a touch display or touch screen of a computing device. The gesture module 106 can detect a touch gesture that is performed or initiated at least partially at or within the certain region where the graphical element is presented. More details regarding the gesture module 106 will be provided below with reference to FIG. 2A.

The text property module 108 can be configured to facilitate modifying, based on the gesture performed with respect to the graphical element, at least one property associated with text to be provided as input. For instance, based on what type of gesture is performed, the text property module 108 can modify a format, style, font, size, or header type of the text. The text property module 108 will be discussed in more detail with reference to FIG. 2B.

Additionally, in some implementations, the text indicator module 104 can be configured to facilitate modifying, based on the gesture, an appearance of the graphical element via a transitional animation. In some cases, the appearance of the graphical element can be associated with one or more characters presented within an icon. In some embodiments, the text indicator module 104 can cause modifying the appearance of the graphical element to include at least one of switching between a bold style and a non-bold style for the one or more characters, switching between an italic style and a non-italic style for the one or more characters, switching between an underline style and a non-underline style for the one or more characters, switching through font sizes for the one or more characters, or switching through header styles for the one or more characters. For example, the text indicator module 104 can cause the appearance of the one or more characters to switch between the bold style and the non-bold style when a tapping gesture is detected, to switch between the italic style and the non-italic style for the one or more characters when a horizontal swiping gesture is detected, to switch between the underline style and the non-underline style for the one or more characters when a pressing/holding gesture is detected, and to switch through the font sizes and/or the header styles for the one or more characters when a vertical swiping gesture is detected. Moreover, in some instances, the transitional animation can include a cross-fading animation effect, a springy animation effect (e.g., appearing to spring left and/or right in response to a horizontal swipe gesture), a bouncy animation effect (e.g., appearing to stretch left and/or right in response to a horizontal swipe gesture), and/or other animation effects. It is contemplated that all examples herein are provided for illustrative purposes and that there can be many variations or other possibilities.

Furthermore, in some embodiments, the gesture-based text modification module 102 can be configured to communicate and/or operate with the at least one data store 110, as shown in the example system 100. The at least one data store 110 can be configured to store and maintain various types of data. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the at least one data store 110 can store information that is utilized by the gesture-based text modification module 102, such as mappings between gestures and text modification operations. Again, it is contemplated that there can be many variations or other possibilities.

FIG. 2A illustrates an example gesture module 202 configured to facilitate gesture-based modification of text to be inputted, according to an embodiment of the present disclosure. In some embodiments, the gesture module 106 of FIG. 1 can be implemented as the example gesture module 202. As shown in FIG. 2A, the gesture module 202 can include a tap module 204, a swipe module 206, and a hold module 208.

As discussed previously, the gesture module 202 can facilitate detecting a gesture performed with respect to a graphical element, which can indicates that text is capable of being provided by a user to be received by a computing device (or system) as input. In some embodiments, the gesture module 202 can utilize the tap module 204 to detect that at least one of a tap, a touch, a press, or a click, etc., is performed with respect to the graphical element. In one example, if the user uses his or her finger or thumb to tap, touch, or press, etc., the graphical element, which can be presented via a touch display of the computing device, the tap module 204 can operate in conjunction with the touch display to detect, recognize, or identify the tap, touch, or press, etc., being performed with respect to the graphical element. In another example, if the user uses a stylus to tap, touch, or press, etc., the graphical element, the tap module 204 can also detect, recognize, or identify the tap, touch, or press, etc., being performed with respect to the graphical element. Many variations are possible.

In some implementations, the gesture module 202 can utilize the swipe module 206 to detect that a first swiping gesture within an allowable deviation of being along a first axis is performed with respect to the graphical element. In some cases, the swipe module 206 can detect that the first swiping (or flicking, sliding, dragging, moving, etc.) gesture is initiated at a display region where the graphical element is presented and can detect that the first swiping gesture continues toward a particular direction substantially along the first axis. For instance, the swiping module 206 can detect a rightward or leftward swiping gesture initiating at the graphical element and continuing substantially along a horizontal axis.

In some embodiments, the gesture module 202 can utilize the swipe module 206 to detect that a second swiping gesture within an allowable deviation of being along a second axis is performed with respect to the graphical element. In some instances, the swipe module 206 can detect that the second swiping (or flicking, sliding, dragging, moving, etc.) gesture is initiated at the display region where the graphical element is presented and can detect that the second swiping gesture continues toward a particular direction substantially along the second axis. For example, the swiping module 206 can detect an upward or downward swiping gesture initiating at the graphical element and continuing substantially along a vertical axis. It should be appreciated that there can be many variations or other possibilities.

Furthermore, in some implementations, the gesture module 202 can utilize the hold module 204 to detect that a pressing gesture is performed with respect to the graphical element for at least a specified threshold amount of time. For instance, the user can utilize his or her finger or a stylus to (press and) hold with respect to the graphical element for at least a predefined minimum duration. The hold module 204 can detect, recognize, or identify such a pressing/holding gesture with respect to the graphical element for at least the predefined minimum duration. Again, it is contemplated that many variations are possible.

FIG. 2B illustrates an example text property modification module 222 configured to facilitate gesture-based modification of text to be inputted, according to an embodiment of the present disclosure. In some embodiments, the text property modification module 108 of FIG. 1 can be implemented as the example text property modification module 222. As shown in FIG. 2B, the text property modification module 222 can include a bold module 224, an italic module 226, a size/header module 228, and an underline module 230.

As discussed above, the text property modification module 222 can facilitate modifying, based on a gesture performed with respect to a graphical element (e.g., as detected by the gesture module 202 of FIG. 2A), at least one property associated with text to be provided as input. With reference to FIG. 2B, in some cases, the text property modification module 222 can utilize the bold module 224 to activate or deactivate a bold style for the text based on a detection of at least one of a tap or a click being performed with respect to the graphical element. In some instances, the text property modification module 222 can utilize the italic module 226 to activate or deactivate an italic style for the text based on a detection of a first swiping gesture being performed with respect to the graphical element. The first swiping gesture can be substantially along a first axis or can be within an allowable deviation of being along the first axis. In one example, the first axis can correspond to a horizontal axis. In this example, the italic style can be activated when the first swiping gesture is performed in a rightward direction and the italic style can be deactivated when the first swiping gesture is performed in a leftward direction, or vice versa.

In some cases, the text property modification module 222 can utilize the size/header module 228 to increase or decrease at least one of a font size or a header style significance (e.g., a level of emphasis for a text heading, a font size for a text heading, and/or an amount of importance signified via an appearance of a text heading, etc.) for the text based on a detection of a second swiping gesture being performed with respect to the graphical element. The second swiping gesture can be substantially along a second axis or can be within an allowable deviation of being along the second axis. In one instance, the second axis can correspond to a vertical axis. In this instance, the font size and/or the header style significance can be increased (e.g., larger font size, more pronounced header style) when the second swiping gesture is performed in an upward direction and the font size and/or the header style significance can be decreased (e.g., smaller font size, less pronounced header style) when the second swiping gesture is performed in a downward direction, or vice versa. Moreover, in some cases, the size/header module 228 can switch through (e.g., cycle through, oscillate through, etc.) a set of header styles for the text based on a detection of a pressing (or holding) gesture being performed with respect to the graphical element for at least a specified threshold amount of time.

Furthermore, in some embodiments, the text property modification module 222 can utilize the underline module 230 to activate or deactivate an underline style for the text based on a detection of a pressing gesture being performed with respect to the graphical element for at least a specified threshold amount of time. As discussed, it should be understood that many variations are possible.

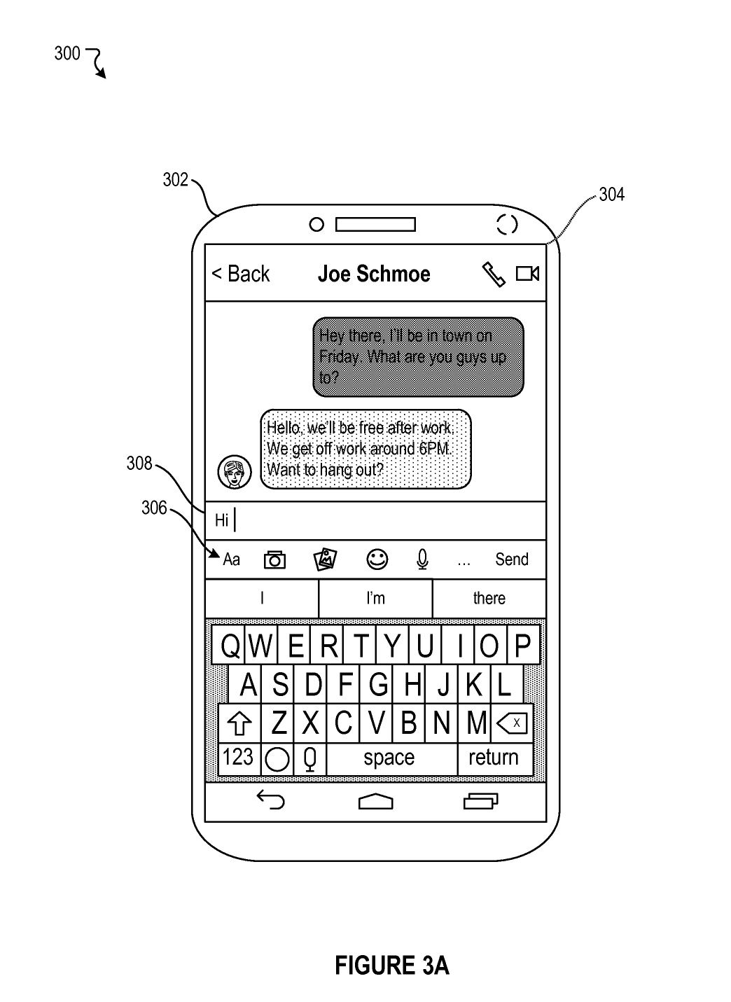

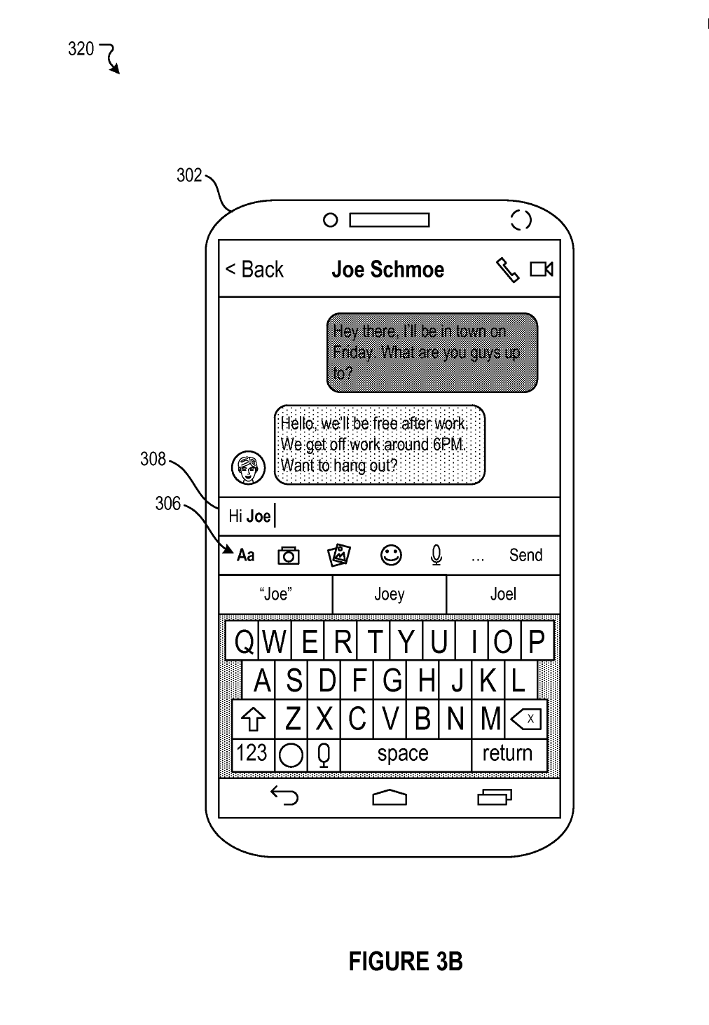

FIG. 3A illustrates an example scenario 300 associated with gesture-based modification of text to be inputted, according to an embodiment of the present disclosure. As shown, the example scenario 300 illustrates a computing device 302 (e.g., the user device 710 of FIG. 7) which provides a communications interface 304, such as a messaging window.

In the example scenario 300 of FIG. 3A, the communications interface 304 can enable a user of the computing device 302 to communicate with another user (e.g., Joe Schmoe). As shown, the computing device 302 can present a graphical element 306, such as an icon displaying the characters “Aa”, which indicates that text is capable of being provided as input (e.g., provided by the user as input to be received by the computing device 302). Moreover, the computing device 302 can provide a text input field 308 capable of receiving and displaying text to be provided as input.

FIG. 3B illustrates an example scenario 320 associated with gesture-based modification of text to be inputted, according to an embodiment of the present disclosure. The example scenario 320 illustrates the example computing device 302 of FIG. 3A. In the example scenario 320 of FIG. 3B, the user has performed a tapping gesture (e.g., a tap, a click, or a press, etc.) with respect to the graphical element 306. This can cause the appearance of the graphical element 306 to change via a transitional animation. As shown, based on the user's tapping gesture, the characters “Aa” of the graphical element 306 can be changed via the transitional animation into a bold style (e.g., “Aa”). Moreover, this can cause (a text style property of) the text to be provided as input by the user to have a bold style as well. As shown in the example scenario 320, subsequent to the user's tapping gesture with respect to the graphical element 306, the text inputted by the user can be bolded (e.g., “Joe”). In this example, in order for the text to revert back to a non-bold style, the user can perform another tapping gesture with respect to the graphical element 306. It should be understood that many variations are possible.

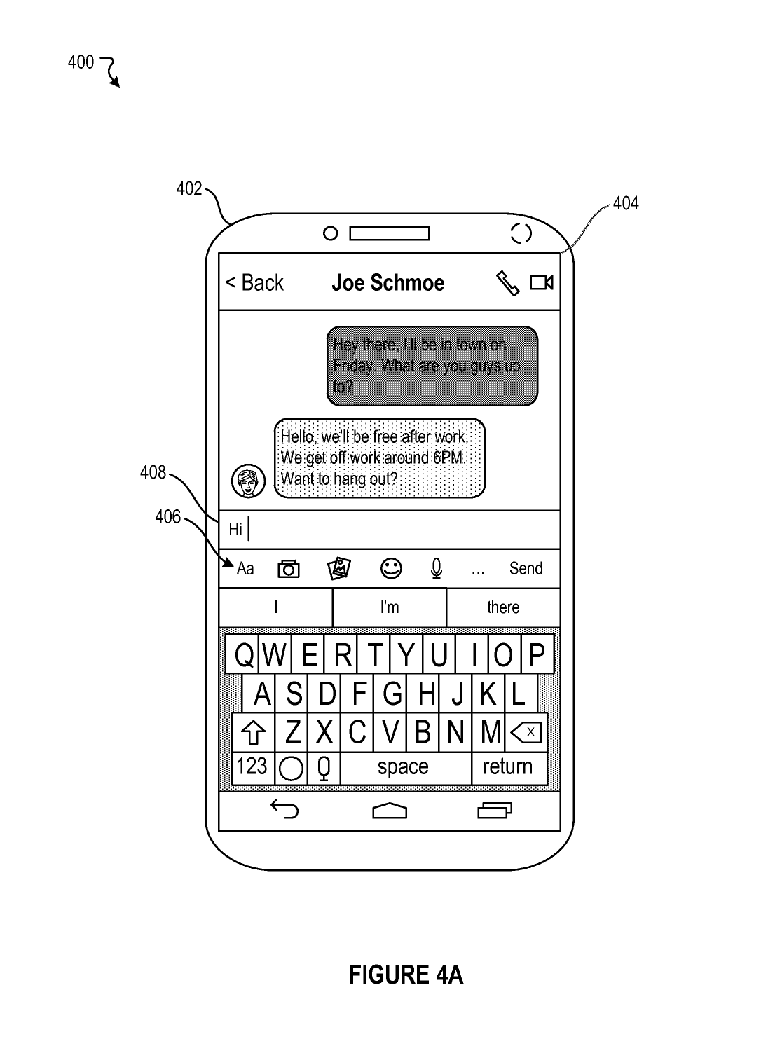

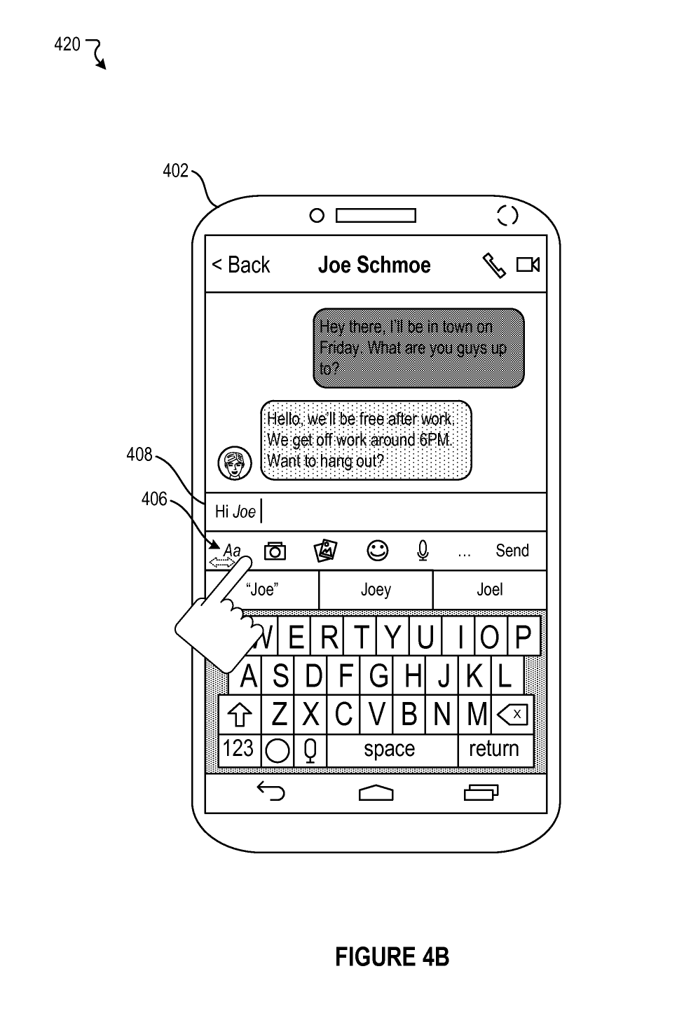

FIG. 4A illustrates an example scenario 400 associated with gesture-based modification of text to be inputted, according to an embodiment of the present disclosure. As shown, the example scenario 400 illustrates a computing device 402 (e.g., the user device 710 of FIG. 7) which provides a communications interface 404, such as a messaging window.

In the example scenario 400 of FIG. 4A, the communications interface 404 can enable a user of the computing device 402 to communicate with another user (e.g., Joe Schmoe). As shown, the computing device 402 can present a graphical element 406, such as an icon displaying the characters “Aa”, which indicates that text is capable of being provided as input (e.g., provided by the user as input to be received by the computing device 402). Moreover, the computing device 402 can provide a text input field 408 capable of receiving and displaying text to be provided as input.

FIG. 4B illustrates an example scenario 420 associated with gesture-based modification of text to be inputted, according to an embodiment of the present disclosure. The example scenario 420 illustrates the example computing device 402 of FIG. 4A. In the example scenario 420 of FIG. 4B, the user has performed a swiping gesture (e.g., a swipe, a flick, a drag, etc.) with respect to the graphical element 406. This can cause the appearance of the graphical element 406 to change via a transitional animation. As shown, based on the user's swiping gesture (e.g., a rightward swiping gesture), the characters “Aa” of the graphical element 406 can be changed via the transitional animation into an italicized style (e.g., “Aa”). Moreover, this can cause (a text style property of) the text to be provided as input by the user to have an italic style as well. As shown in the example scenario 420, subsequent to the user's swiping gesture with respect to the graphical element 406, the text inputted by the user can be italicized (e.g., “Joe”). In this example, in order for the text to revert back to a non-italic style, the user can perform another swiping gesture in an opposite direction (e.g., a leftward swiping gesture) with respect to the graphical element 406. Again, it is contemplated that all examples herein are provided for illustrative purposes and that there can be many variations or other possibilities.

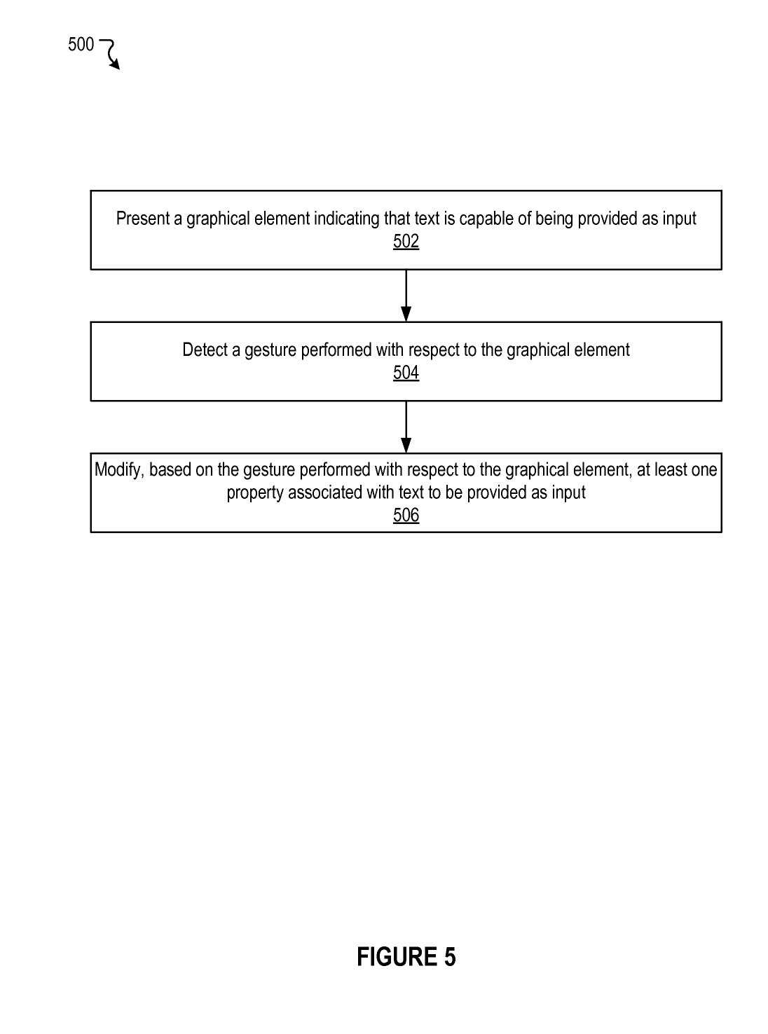

FIG. 5 illustrates an example method 500 associated with gesture-based modification of text to be inputted, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can present a graphical element indicating that text is capable of being provided as input. At block 504, the example method 500 can detect a gesture performed with respect to the graphical element. At block 506, the example method 500 can modify, based on the gesture performed with respect to the graphical element, at least one property associated with text to be provided as input.

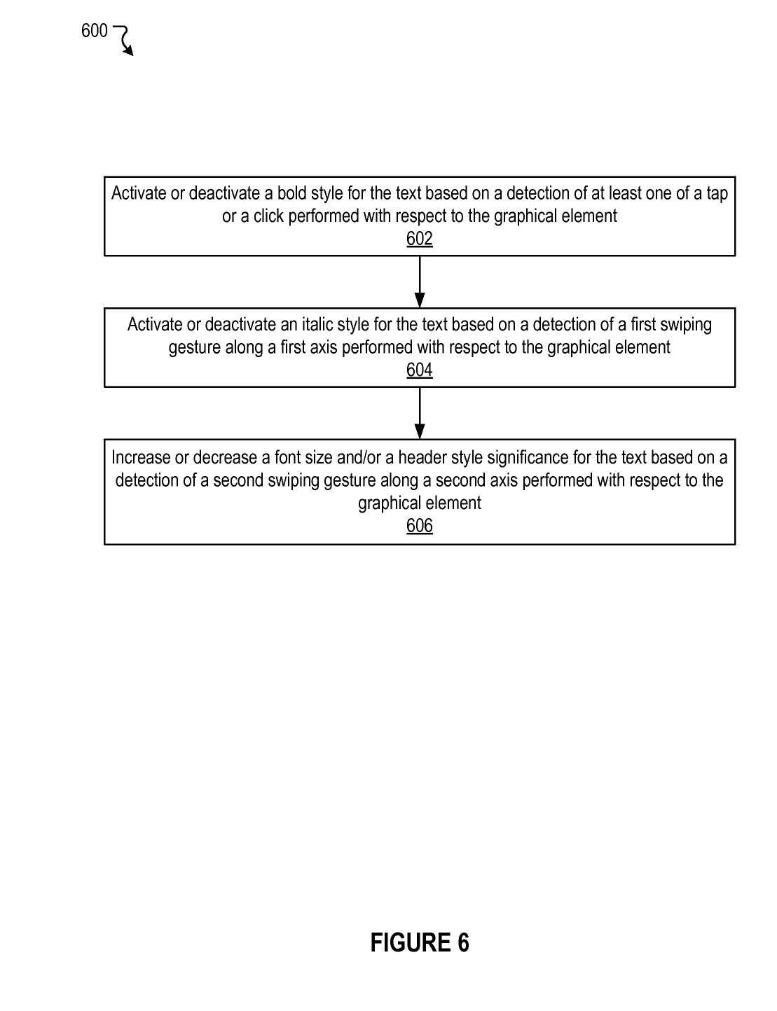

FIG. 6 illustrates an example method 600 associated with gesture-based modification of text to be inputted, according to an embodiment of the present disclosure. As discussed, it should be understood that there can be additional, fewer, or alternative steps performed in similar or alternative orders, or in parallel, within the scope of the various embodiments unless otherwise stated.

At block 602, the example method 600 can activate or deactivate a bold style for the text to be provided as input based on a detection of at least one of a tap or a click performed with respect to the graphical element. At block 604, the example method 600 can activate or deactivate an italic style for the text to be provided as input based on a detection of a first swiping gesture within an allowable deviation of being along a first axis performed with respect to the graphical element. At block 606, the example method 600 can increase or decrease at least one of a font size or a header style significance for the text to be provided as input based on a detection of a second swiping gesture within an allowable deviation of being along a second axis performed with respect to the graphical element.

It is contemplated that there can be many other uses, applications, features, possibilities, and/or variations associated with the various embodiments of the present disclosure. For example, in some instances, the disclosed technology can utilize a tutorial or a set of instructions (e.g., prompts such as “Tap Aa for bold text” and “Swipe Aa for italic text” can be presented in conjunction with the graphical element). Moreover, in some cases, users can choose whether or not to opt-in to utilize the disclosed technology. The disclosed technology can, for instance, also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the user device 710 can include a gesture-based text modification 718. The gesture-based text modification 718 can, for example, be implemented as the gesture-based text modification 102 of FIG. 1. As discussed previously, it should be appreciated that there can be many variations or other possibilities. For example, in some instances, the gesture-based text modification 718 (or at least a portion thereof) can be included in the social networking system 730. Other features of the gesture-based text modification 718 are discussed herein in connection with the gesture-based text modification 102.

### Hardware Implementation

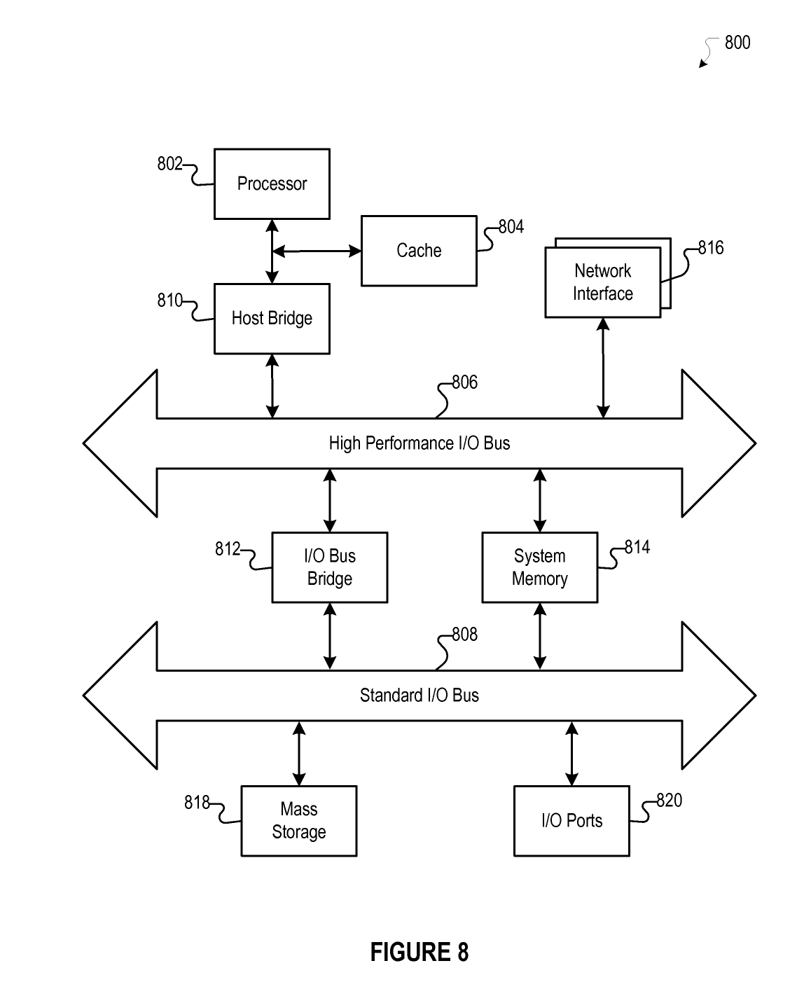

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments. Furthermore, reference in this specification to “based on” can mean “based, at least in part, on”, “based on at least a portion/part of”, “at least a portion/part of which is based on”, and/or any combination thereof.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
presenting, by a computing system, a graphical element indicating that text is capable of being provided as input;
detecting, by the computing system, a gesture performed with respect to the graphical element; and
modifying, by the computing system, based on the gesture performed with respect to the graphical element, at least one property associated with text to be provided as input.

2. The computer-implemented method of claim 1, wherein detecting the gesture includes detecting that at least one of a tap or a click is performed with respect to the graphical element, and wherein modifying the at least one property associated with the text to be provided as input includes activating or deactivating a bold style for the text to be provided as input.

3. The computer-implemented method of claim 1, wherein detecting the gesture includes detecting that a first swiping gesture within an allowable deviation of being along a first axis is performed with respect to the graphical element, and wherein modifying the at least one property associated with the text to be provided as input includes activating or deactivating an italic style for the text to be provided as input.

4. The computer-implemented method of claim 3, wherein the first axis corresponds to a horizontal axis, wherein the italic style is activated when the first swiping gesture is performed in a rightward direction, and wherein the italic style is deactivated when the first swiping gesture is performed in a leftward direction.

5. The computer-implemented method of claim 1, wherein detecting the gesture includes detecting that a second swiping gesture within an allowable deviation of being along a second axis is performed with respect to the graphical element, and wherein modifying the at least one property associated with the text to be provided as input includes increasing or decreasing at least one of a font size or a header style significance for the text to be provided as input.

6. The computer-implemented method of claim 5, wherein the second axis corresponds to a vertical axis, wherein the at least one of the font size or the header style significance is increased when the second swiping gesture is performed in an upward direction, and the at least one of the font size or the header style significance is decreased when the second swiping gesture is performed in a downward direction.

7. The computer-implemented method of claim 1, wherein detecting the gesture includes detecting that a pressing gesture is performed with respect to the graphical element for at least a specified threshold amount of time, and wherein modifying the at least one property associated with the text to be provided as input includes switching through a set of header styles for the text to be provided as input.

8. The computer-implemented method of claim 1, wherein detecting the gesture includes detecting that a pressing gesture is performed with respect to the graphical element for at least a specified threshold amount of time, and wherein modifying the at least one property associated with the text to be provided as input includes activating or deactivating an underline style for the text to be provided as input.

9. The computer-implemented method of claim 1, further comprising:
modifying, based on the gesture, an appearance of the graphical element via a transitional animation.

10. The computer-implemented method of claim 9, wherein the appearance of the graphical element is associated with one or more characters presented within an icon, and wherein modifying the appearance of the graphical element includes at least one of switching between a bold style and a non-bold style for the one or more characters, switching between an italic style and a non-italic style for the one or more characters, switching between an underline style and a non-underline style for the one or more characters, switching through font sizes for the one or more characters, or switching through header styles for the one or more characters.

11. A system comprising:
at least one processor; and
a memory storing instructions that, when executed by the at least one processor, cause the system to perform:
presenting a graphical element indicating that text is capable of being provided as input;
detecting a gesture performed with respect to the graphical element; and
modifying, based on the gesture performed with respect to the graphical element, at least one property associated with text to be provided as input.

12. The system of claim 11, wherein detecting the gesture includes detecting that at least one of a tap or a click is performed with respect to the graphical element, and wherein modifying the at least one property associated with the text to be provided as input includes activating or deactivating a bold style for the text to be provided as input.

13. The system of claim 11, wherein detecting the gesture includes detecting that a first swiping gesture within an allowable deviation of being along a first axis is performed with respect to the graphical element, and wherein modifying the at least one property associated with the text to be provided as input includes activating or deactivating an italic style for the text to be provided as input.

14. The system of claim 11, wherein detecting the gesture includes detecting that a second swiping gesture within an allowable deviation of being along a second axis is performed with respect to the graphical element, and wherein modifying the at least one property associated with the text to be provided as input includes increasing or decreasing at least one of a font size or a header style significance for the text to be provided as input.

15. The system of claim 11, wherein the instructions cause the system to further perform:
modifying, based on the gesture, an appearance of the graphical element via a transitional animation.

16. A non-transitory computer-readable storage medium including instructions that, when executed by at least one processor of a computing system, cause the computing system to perform a method comprising:
presenting a graphical element indicating that text is capable of being provided as input;
detecting a gesture performed with respect to the graphical element; and
modifying, based on the gesture performed with respect to the graphical element, at least one property associated with text to be provided as input.

17. The non-transitory computer-readable storage medium of claim 16, wherein detecting the gesture includes detecting that at least one of a tap or a click is performed with respect to the graphical element, and wherein modifying the at least one property associated with the text to be provided as input includes activating or deactivating a bold style for the text to be provided as input.

18. The non-transitory computer-readable storage medium of claim 16, wherein detecting the gesture includes detecting that a first swiping gesture within an allowable deviation of being along a first axis is performed with respect to the graphical element, and wherein modifying the at least one property associated with the text to be provided as input includes activating or deactivating an italic style for the text to be provided as input.

19. The non-transitory computer-readable storage medium of claim 16, wherein detecting the gesture includes detecting that a second swiping gesture within an allowable deviation of being along a second axis is performed with respect to the graphical element, and wherein modifying the at least one property associated with the text to be provided as input includes increasing or decreasing at least one of a font size or a header style significance for the text to be provided as input.

20. The non-transitory computer-readable storage medium of claim 16, wherein the instructions cause the computing system to further perform:
modifying, based on the gesture, an appearance of the graphical element via a transitional animation.
